(19) United States
(12) Patent Application Publication
(10) Pub. No.: US 2026/0241397 A1
(43) Pub. Date: Aug. 20, 2026

(54) ELECTROSTATIC COATING SYSTEM

(71) Applicant: AM Batteries, Inc., Billerica, MA (US)

(72) Inventors: Omri Flaisher, Litchfield, NH (US); Jay Jie Shi, Acton, MA (US)

(73) Assignee: AM Batteries, Inc., Billerica, MA (US)

(21) Appl. No.: 19/161,027

(22) PCT Filed: Mar. 4, 2024
(86) PCT No.: PCT/US2024/018424

§ 371 Date: Aug. 29, 2025

Related U.S. Application Data
(60) Provisional application No. 63/449,475, filed on Mar. 2, 2023.

(51) Int. Cl. B05B 5/025; B05B 5/03; B05D 1/06

(52) U.S. Cl. CPC B05B 5/025; B05B 5/032; B05D 1/06

(57) ABSTRACT

An example electrostatic coating system is provided. The system includes a coating chamber configured to receive a dry powder mixture, and further configured to receive a web including a top surface and an opposing bottom surface that travels through the coating chamber. The system includes a dispensing assembly configured to dispense the dry powder mixture into the coating chamber. The system includes a charging assembly associated with the coating chamber. The system includes an airflow system configured to control airflow passing through the coating chamber.

### CROSS-REFERENCE TO RELATED APPLICATIONS

This application claims the benefit of a co-pending U.S. Provisional Patent Application No. 63/449,475, which was filed on Mar. 2, 2023. The entire content of the foregoing provisional application is incorporated herein by reference.

### BACKGROUND

A variety of batteries are available in the industry for different uses. Lithium-ion (Li-ion) batteries have generally become the predominant type of battery used in portable consumer electronics and electric vehicles. Fabrication of Li-ion batteries involves numerous steps, each of which can affect the quality of the battery itself, as well as the cost involved in manufacturing the battery. A conventional manufacturing process generally includes formation of an electrode slurry having an active material, a conductive additive, and a binder, mixed in an organic solvent, and the electrode slurry is applied to a metal foil material. Once applied to the foil material, the solvent is dried out or evaporated while the active electrode mixture remains attached to the metal foil material surface. In some instances, the solvent may be toxic and can necessitate additional steps for handling/discarding that increase the overall cost of the manufacturing process. The cost of removing the solvent from the coated material on the metal foil therefore involves an additional step that also increases the overall cost of the manufacturing process.

An alternative manufacturing technique used in the industry is electrostatic spray deposition (ESD), which is a solvent-free manufacturing process for electrode coating for Li-ion batteries. (See, e.g., B. Ludwig et al., Solvent-Free Manufacturing of Electrodes for Lithium-ion Batteries, Sci. Rep. 6, Article No. 23150, doi:10.1038/srep23150 (2016); M. Wang et al., The Influence of Polyvinylidene Fluoride (PVDF) Binder Properties on LiNi_{0.33}Co_{0.33}Mn_{0.33}O₂ (NMC) Electrodes Made by a Dry-Powder-Coating Process, J. Electrochem. Soc., Vol. 166, No. 10, A2151 (2019); H. Abe et al., Electrostatic Spray Deposition for Fabrication of Li-ion Batteries, Transactions of JWRI, Vol. 44, No. 2(2015 ); and U.S. Pat. No. 10,547,044). Rather than relying on a solvent mixture, the ESD process uses a dry powder of the active electrode mixture which is applied to the metal foil material. By removing the solvent from the mixture and the drying step from the manufacturing process, the overall process is simplified and becomes more economic, resulting in a viable alternative for large-scale manufacturing. In particular, the solvent-free electrode coating technology is an attractive alternative to traditional manufacturing since it can significantly reduce energy consumption in the manufacturing process and thus significantly reduce the manufacturing cost of batteries.

In a conventional dry powder ESD coating system, a web (e.g., a grounded electrically conductive substrate) passes continuously through a coating chamber while the dry powder mixture is dispensed from a hopper. An air supply system provides a high velocity air stream into the coating chamber to fluidize the dispensed powder and carry the fluidized powder particles to the electric field for electrostatically charging and to deposit on the web for distribution and coating. However, the use of high velocity air leads to an inherent kinetic energy of the power particles in the air stream as being a dominant force during deposition, which diminishes the ESD capability to produce a highly uniform coating of the powder particles on the web. This lack of uniform coating is typically because the entire mass of powder particles must be diluted and carried in the air stream, which requires a high velocity to obtain a reasonable mass flow rate for production needs. As such, conventional ESD coating systems are unable to offer a high degree of controlled uniformity of the powder particles on the web at high mass flow rates.

### SUMMARY

Embodiments of the present disclosure provide an electrostatic coating system capable of being used for coating a substrate or web with dry powder. The electrostatic coating system includes an air supply configured to direct laminar or controlled turbulent air into the coating chamber to disperse the dry powder supplied from a powder scattering unit.

The electrostatic coating system includes corona discharge producing electrodes positioned within the coating chamber configured to both electrostatically charge the dry powder particles within the coating chamber and also provide a guiding function to guide or direct the electrostatically charged powder particles towards the substrate or web. Thus, rather than relying solely on the high air flow for distribution of powder on the substrate or web (as done in conventional ESD systems), the exemplary coating system uses at least some of the electrodes within the coating chamber to guide the electrostatically charged powder particles, by controlling the airflow to a tight degree, thereby achieving a more uniform and operationally efficient distribution/coating of particles on the substrate or web.

In accordance with embodiments of the present disclosure, an exemplary electrostatic coating system is provided. The system includes a coating chamber configured to receive a dry powder mixture. The coating chamber is configured to receive a web including a top surface and an opposing bottom surface that travels through the coating chamber. The system includes electrodes disposed within the coating chamber. The electrodes operate as dual function electrodes by electrostatically charging particles of the dry powder mixture introduced into the coating chamber, and once the particles of the dry powder mixture have been electrostatically charged, guiding the electrostatically charged particles towards the web. The created electric field between the electrodes and the web guides the charged powder particles to travel in the electric field towards the web.

In some embodiments, the dry powder mixture can include active materials, binder, and conductive additives. In some embodiments, the system can include a hopper positioned over the coating chamber. The hopper can be configured to receive the dry powder mixture and introduce the dry powder mixture into the coating chamber. In some embodiments, the system can include a dispensing roller (e.g., mechanical dispersion means) disposed below the hopper. The dispensing roller can rotate to initially disperse the dry powder mixture into the coating chamber.

In some embodiments, the system can include an air supply means for directing air flow into the coating chamber to disperse the dry powder mixture over the web. In some embodiments, a turbulence reduction structure can be disposed upstream of the coating chamber and configured to control turbulence in the air flow to achieve laminar or turbulently controlled air flow prior to entry of the laminar air flow into the coating chamber. In some embodiments, the turbulence reduction structure can include an array of openings through which the air flow passes. In some embodiments, the openings of the array can each define a honeycomb configuration. Typically, the turbulence controlling structure is between about, e.g., 50-90% inclusive, 50-80% inclusive, 50-70% inclusive, 50-60% inclusive, 60-90% inclusive, 70-90% inclusive, 80-90% inclusive, 60-80% inclusive, 50%, 60%, 70%, 80%, 90%, or the like, open from an area cross-section perspective.

The electrodes can be positioned in a narrowing configuration with a distance between adjacently positioned electrodes and the web gradually reducing in a downstream direction of the coating chamber. The narrowing configuration can be an arc configuration or a linear configuration shifting downwardly towards the web in the downstream direction of the coating chamber to guide the electrostatically charged particles towards the web for coating. Each of the electrodes in the narrowing configuration can be physically spaced from each other by both a vertical and horizontal distance relative to the web. Each of the electrodes can be capable of electrostatically charging the particles and guiding the electrostatically charged particles.

In some embodiments, the system can include a deflection shield disposed within the coating chamber to control and limit the mobility of ions and charged particles formed by the corona discharge. The deflection shield can include at least one of a first section disposed at least partially below a dispensing roller to prevent return of the particles to the dispensing roller, a curved section disposed above the narrowing configuration of the electrodes, combinations thereof, or the like. The curved section can define a curvature complementary to the narrowing configuration of the electrodes, with a distance of a first end of the curved section further from the web than a distance of an opposing second end of the curved section. In some embodiments, the curved section can assist with guiding the electrostatically charged particles towards the web.

In some embodiments, the system can include an exhaust assembly with negative pressure air to remove fugitive particles that have not coated the web. In some embodiments, the system can include a diffuser disposed upstream of the exhaust assembly. The diffuser can include a narrow opening oriented directly above the web.

In accordance with embodiments of the present disclosure, an exemplary electrostatic coating system is provided. The system includes a coating chamber configured to receive a dry powder mixture. The coating chamber is configured to receive a web including a top surface and an opposing bottom surface that travels through the coating chamber. The system includes electrodes disposed within the coating chamber in a narrowing configuration with a distance between adjacently positioned electrodes and the web gradually reducing in a downstream direction of the coating chamber. The electrodes operate as dual function electrodes by electrostatically charging particles of the dry powder mixture introduced into the coating chamber, and once the particles of the dry powder mixture have been electrostatically charged, guiding the electrostatically charged particles towards the web.

In accordance with embodiments of the present disclosure, an exemplary method of electrostatic dry powder coating is provided. The method includes passing a web through a coating chamber of an electrostatic coating system. The web includes a top surface and an opposing bottom surface. The method includes introducing a dry powder mixture into the coating chamber. The method includes electrostatically charging particles of the dry powder mixture with electrodes disposed within the coating chamber. The method includes guiding the electrostatically charged particles towards the web.

In accordance with embodiments of the present disclosure, an exemplary electrostatic coating system is provided. The system includes a coating chamber configured to receive a dry powder mixture. The coating chamber is configured to receive a web including a top surface and an opposing bottom surface that travels through the coating chamber. The system includes a dispensing assembly configured to dispense the dry powder mixture into the coating chamber. The system includes a charging assembly associated with the coating chamber. The system includes an airflow system configured to control airflow passing through the coating chamber.

In some embodiments, the charging assembly can include electrodes disposed within the coating chamber. The electrodes can operate as dual function electrodes by (i) electrostatically charging particles of the dry powder mixture introduced into the coating chamber, and (ii) once the particles of the dry powder mixture have been electrostatically charged, guiding the electrostatically charged particles towards the web.

The dry powder mixture can include active materials, binder, and conductive additives. The dispensing assembly can include a hopper positioned over the coating chamber. The hopper is configured to receive the dry powder mixture and introduce the dry powder mixture into the coating chamber. The dispensing assembly can include a dispensing roller disposed below the hopper. The dispensing roller rotates to initially disperse the dry powder mixture into the coating chamber.

The airflow system can include an air supply means for directing air flow into the coating chamber to disperse the dry powder mixture over the web. In some embodiments, the airflow system can maintain an air velocity of about 25-750 fpm, inclusive, through the coating chamber. In some embodiments, the airflow system can include a turbulence controlling structure disposed upstream of the coating chamber and configured to control turbulence in the air flow. The turbulence controlling structure can be configured to control the turbulence in the air flow to achieve laminar air flow prior to entry of the laminar air flow into the coating chamber. In some embodiments, the turbulence controlling structure can include an array of openings through which the air flow passes. In some embodiments, the openings of the array can each define a honeycomb configuration. In some embodiments, the turbulence controlling structure can define an open cross-sectional area between about 50-90%, inclusive. The airflow system can include an air supply means for directing air flow into the coating chamber to guide the dry powder mixture introduced into the chamber towards the charging assembly.

In some embodiments, the electrodes can be positioned in a narrowing configuration with a distance between adjacently positioned electrodes and the web gradually reducing in a downstream direction of the coating chamber. In some embodiments, the narrowing configuration can be an arc configuration or a linear configuration shifting downwardly towards the web in the downstream direction of the coating chamber to guide the electrostatically charged particles towards the web for coating. Each of the electrodes in the narrowing configuration can be physically spaced from each other by both a vertical and horizontal distance relative to the web.

Each of the electrodes can be capable of electrostatically charging the particles and guiding the electrostatically charged particles. In some embodiments, the system can include a deflection shield disposed within the coating chamber to control mobility of ions and charged particles created by corona discharge. The deflection shield can include at least one of (i) a first section disposed at least partially below a dispensing roller to prevent return of the particles to the dispensing roller, and (ii) a curved section disposed above the narrowing configuration of the electrodes. The curved section can define a curvature complementary to the narrowing configuration of the electrodes, with a distance of a first end of the curved section further from the web than a distance of an opposing second end of the curved section. The curved section can assist with guiding the electrostatically charged particles towards the web. In some embodiments, the airflow system can include an exhaust assembly with negative pressure air to remove fugitive particles that have not coated the web.

In accordance with embodiments of the present disclosure, an exemplary method of electrostatic dry powder coating is provided. The method includes passing a web through a coating chamber of an electrostatic coating system. The web includes a top surface and an opposing bottom surface. The method includes dispensing a dry powder mixture into the coating chamber with a dispensing assembly. The method includes controlling airflow passing through the coating chamber with an airflow system. The method includes charging particles of the dry powder mixture with a charging assembly.

Charging the particles of the dry powder mixture with the charging assembly can include electrostatically charging the particles of the dry powder mixture with electrodes of the charging assembly. The method includes guiding the electrostatically charged particles towards the web with the electrodes of the charging assembly.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the electrostatic coating system with guiding electrodes, reference is made to the accompanying figures, wherein:

FIG. 1 is a diagrammatic view of an exemplary electrostatic coating system in accordance with embodiments of the present disclosure, with the electrostatic coating system in a horizontal orientation and electrodes in an arc configuration;

FIG. 2 is a diagrammatic view of an exemplary electrostatic coating system in accordance with embodiments of the present disclosure, with the electrostatic coating system in a vertical orientation and electrodes in an arc configuration;

FIG. 3 is a diagrammatic view of an exemplary electrostatic coating system in accordance with embodiments of the present disclosure, with a dual-sided simultaneous coating configuration and electrodes in an arc configuration;

FIG. 4 is a diagrammatic view of an exemplary electrostatic coating system in accordance with embodiments of the present disclosure, with a dual-sided offset coating configuration and electrodes in an arc configuration;

FIG. 5 is a diagrammatic view of an exemplary electrostatic coating system in accordance with embodiments of the present disclosure, with a single-sided in series coating configuration and electrodes in an arc configuration;

FIG. 6 is a diagrammatic view of an exemplary electrostatic coating system in accordance with embodiments of the present disclosure, with the electrostatic coating system in a horizontal orientation and electrodes in a linear configuration;

FIG. 7 is a diagrammatic view of an exemplary electrostatic coating system in accordance with embodiments of the present disclosure, including mechanical dispersion means; and

FIG. 8 is a diagrammatic view of an exemplary electrostatic coating system in accordance with embodiments of the present disclosure, including gravity dispersion means.

### DETAILED DESCRIPTION

The exemplary electrostatic coating system includes air dispersion of a dispensed powder stream for a continuous moving web, and further includes electrodes configured to electrostatically charge the powder particles by means of corona discharge and provide a guiding force to the electrostatically charged particles to direct the particles as a uniform coating on the web with high uniformity and high first pass transfer efficiencies. In some embodiments, all electrodes of the system can be configured to provide both a charging functionality and a guiding functionality. In some embodiments, some electrodes can be used exclusively to provide a charging functionality and some electrodes can be used exclusively to provide a guiding functionality. In some embodiments, the type of functionality of the electrodes can be dependent on a distance of the electrode position relative to the powder dispensing machine output, with electrodes closest to the output providing more of the charging functionality, electrodes furthest to the output providing more of the guiding functionality, and electrodes in-between providing both the charging and guiding functionality. The position and/or spacing of the electrodes within the coating and/or electrostatic charging chamber is described herein as only exemplary, and it should be understood that alternative positions of the electrodes could be used, e.g., the electrode positioning described in International Patent Application No. PCT/US23/26276, filed on Jun. 27, 2023, which is incorporated herein by reference in its entirety.

The system decouples the powder carrying/conveying process (e.g., dispensing) from the dispersion air stream by using a powder dispensing roller/brush to dispense the powder along the width of the web and includes an air supply that provides a uniform laminar air stream to disperse the powder stream longitudinally down the web direction. The dispersion of the powder stream reduces the powder cloud density (e.g., powder stream) coming out of the powder dispensing roll feeding the ESD charging zones to ensure that there is efficient powder charging with the number and/or location of wire electrodes disposed within the chamber. Although discussed with respect to a horizontal orientation and a vertical orientation of the system, it should be understood that the system can be used in any orientation (e.g., any angle between the horizontal or 0° orientation and the vertical or 90° orientation). The system can therefore be orientation agnostic, with appropriate adjustment of the air stream generation position/direction and the direction of flow of the powder. In some embodiments, the system can be used to provide simultaneous dual-sided coating of the web.

In some embodiments, the system allows for the use of highly laminar, uniform air as a down-web dispersion mechanism for a dense dispensed powder stream into an electrostatic charging zone. The air supply assembly or system can be any type known in the industry, e.g., a cyclone vacuum, a positive pressure blower, a negative pressure blower, combinations thereof, or the like. The air supply system can provide filtered and diffused air into the coating chamber. The air source can either be a “push” system or “pull” system.

In some embodiments, in an effort to reduce the effective Reynolds number where the air carries the powder particles, specific air inlet designs can be utilized alone or in combination. Such specific air inlet designs can be referred to herein as “turbulence reducing devices”, and can enable a shorter development length to reduce the overall footprint of the system. In some embodiments, the air intakes can incorporate individually or in combination the following features: bell mouth shaped intakes, diffusion meshes, vanes which can be dynamic or stationary, converging and/or diverging sections, or the like. The diffusion meshes can take the form of, but are not limited to, honeycomb opening arrays and perforated plates of potentially varying widths. There diffusion meshes are typically between about, e.g., 50-90% inclusive, 50-80% inclusive, 50-70% inclusive, 50-60% inclusive, 60-90% inclusive, 70-90% inclusive, 80-90% inclusive, 60-80% inclusive, 50%, 60%, 70%, 80%, 90%, or the like, open area. Each of these features can be specifically calculated based on the coating chamber cross-sectional area and the target conveying velocity to ensure an effective result/operation. In some embodiments, the target conveying velocity can be between about e.g., 25-750 FPM inclusive, 100-750 FPM inclusive, 200-750 FPM inclusive, 300-750 FPM inclusive, 400-750 FPM inclusive, 500-750 FPM inclusive, 600-750 FPM inclusive, 25-700 FPM inclusive, 25-600 FPM inclusive, 25-500 FPM inclusive, 25-400 FPM inclusive, 25-300 FPM inclusive, 25-200 FPM inclusive, 25-100 FPM inclusive, 200-600 FPM inclusive, 300-500 FPM inclusive, 25 FPM, 100 FPM, 200 FPM, 300 FPM, 400 FPM, 500 FPM, 600 FPM, 700 FPM, 750 FPM, or the like, in the machine direction. In some embodiments, the velocity range can be about, e.g., 50-500 FPM inclusive, or the like. The required volumetric flow rate can be calculated based on the target velocity, the chamber cross sectional area, and the pressure drops within the system.

To enable a high degree of coating uniformity, the air steam should have a certain uniformity. The uniformity of the air is most important in regards to the cross-web direction. The lateral uniformity should be less than about +/−5% root mean square (RMS) with a target of less than about +/−1% root mean square. The air velocity uniformity in the z direction (height) can have a gradient as long as the lateral uniformity is maintained. It should be noted that these target air uniformities are required when the powder dispensing stream is uniform to the coating requirements. There can be non-uniformities induced into the air conveying stream to compensate for non-uniformities in the powder dispensing stream to achieve a target coating uniformity. The system includes a tail pipe configured to remove the fugitive powder via vacuum without disturbing the air stream (in the case of a push system) or enable the air stream (in the case of a pull system) within the coating chamber, ensuring a uniform coating of the web. In the case of a pull system, the air stream creation vacuum and the powder collection vacuum could be configured as one unit.

The system includes multi-functional wire electrodes strategically disposed within the coating chamber to charge and direct/guide the powder path within the coating chamber, thereby ensuring a uniform coating of the web. Such dual function of the electrodes increases transfer efficiency and improves the system reliability by minimizing or eliminating powder build up on the wire electrode surfaces and the chamber walls. The system includes wire electrodes with two different functions. A first set of electrodes can be the traditional “corona discharge powder charging wire electrodes”. The second set of electrodes are the “guiding wire electrodes”. The charging wire electrodes are positioned in locations within the coating chamber based on the powder dispensing stream and initial dispersion area from the uniform air stream, such that the majority of the powder is charged.

The charged particle cloud continues to be conveyed by the air stream, but now has an attraction to flow towards the grounded web due to the electrostatic charge. This affinity to the web is generally not strong enough to thoroughly direct the entire powder cloud to the web. The guided wire electrodes assist with directing or guiding the powder cloud to the desired areas of the web. Not only do the charged powder particles have an inherent attraction to the web, they will also be repelled by similar charges and the associated electric fields. The guiding wire electrodes produce similar plasma zones (e.g., corona discharge, or the like), which effectively produce a wall of negatively charged ions, repelling the charged powder particles in the desired location, e.g., towards the web. In some embodiments, the guiding wire electrodes can function to reduce the magnitude of the powder velocity vector in the machine direction by imparting a vector of Coulomb electrical repulsion force on the charged particle, enabling the electrostatic forces to be the dominant force during deposition. The guiding wires can be placed in strategic locations relative to the general charged powder particle flow such that the flow of the charged powder particle cloud is further directed towards the web.

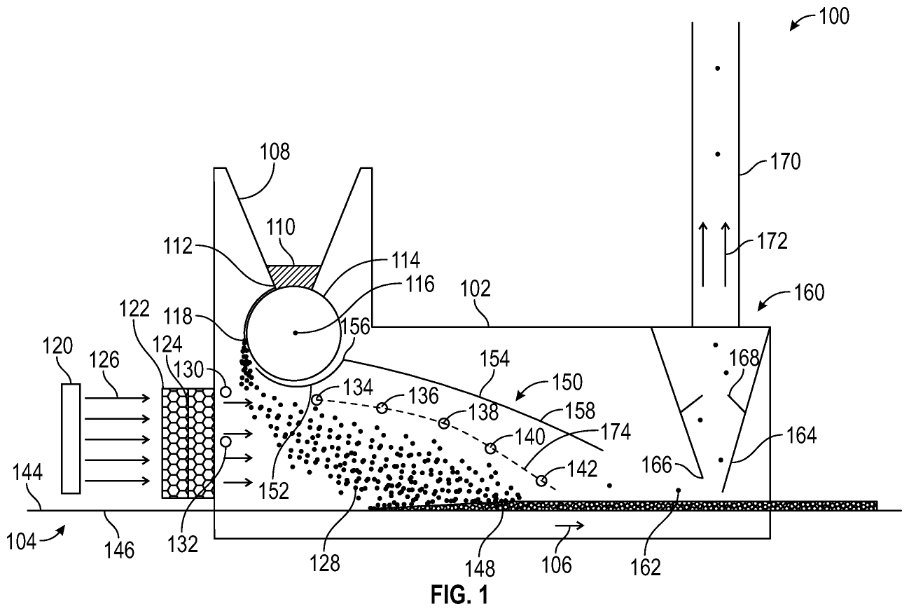

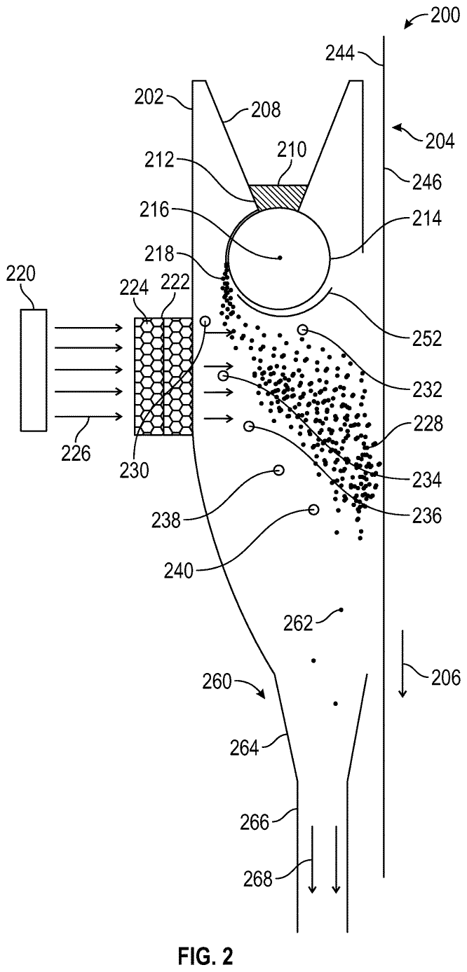

In some embodiments, the guiding wire electrodes can be disposed in a downward arc or downward linear direction towards the web (see, e.g., FIG. 1), guiding/conditioning the powder path. The downward direction of the electrodes is referred to herein as a “narrowing configuration”, and is intended to describe the gradually narrower or reduced distance between the electrodes and the surface of the web in the downstream direction to direct/guide the powder path towards the surface of the web. Although an arc and linear configuration are illustrated, it should be understood that alternative narrowing configurations/positions of the electrodes are also envisioned. In some embodiments, the guiding wire electrodes can be disposed in a rightward or leftward arc towards the web (see, e.g., FIG. 2), guiding/conditioning the powder path. As noted herein, the position and/or spacing of the electrodes within the coating chamber is described herein as only exemplary, and it should be understood that alternative positions of the electrodes could be used, e.g., the electrode positioning described in International Patent Application No. PCT/US23/26276, filed on Jun. 27, 2023, which is incorporated herein by reference in its entirety. In general, the charging wire electrodes should maintain a minimum spacing between other conductive elements, such as other wire electrodes or the grounded web, to minimize/eliminate electrical breakdown in the form of arcing (e.g., based on a function of the applied voltage to the wire). Typically, for voltages used in the ESD application, the spacing can be at least about 1 cm. In some embodiments, the wire electrodes can be, e.g., less than about 45 cm from each other and/or from the web, e.g., less than about 30 cm from each other and/or from the web, or the like.

The system can include a plasma deflection shield within the coating chamber to limit the mobility of the ionized air out of the “guiding zone”, e.g., the zone in which the guiding wire electrodes direct the powder towards the web. The shield can be to isolate the charged powder path from attracting towards the dispensing roll. When charging is first occurring, the powders are highly likely to be closer to the dispensing machine than the web, influencing the flow direction. As such, the shield can be used to prevent attraction of the charged powder path towards the dispensing roll. In some embodiments, the dispensing roll can be fully insulated to eliminate risks of powder coating onto the roll or any other conductive surfaces in the system. This can provide additional protection over the deflection shield.

In some embodiments, the system can incorporate integrated one or more powder reclaim systems for any over sprayed powder which is not collected by the fugitive powder collection vacuum. The power reclaim system can be in the form of one or more configurations that can be implemented individually or in combination. When integrated with the coating system, the powder reclaim system can be configured to prevent inducement of non-uniformities in the air carrying stream, which can be carefully catered to the function of uniform deposition. Some embodiments of this system can include: a belt conveyor, a screw feeder, a vacuum system, combinations thereof, or the like. Depending on the orientation of the coating chamber, the additional features of the system can be adjusted to maximize their operation effectiveness.

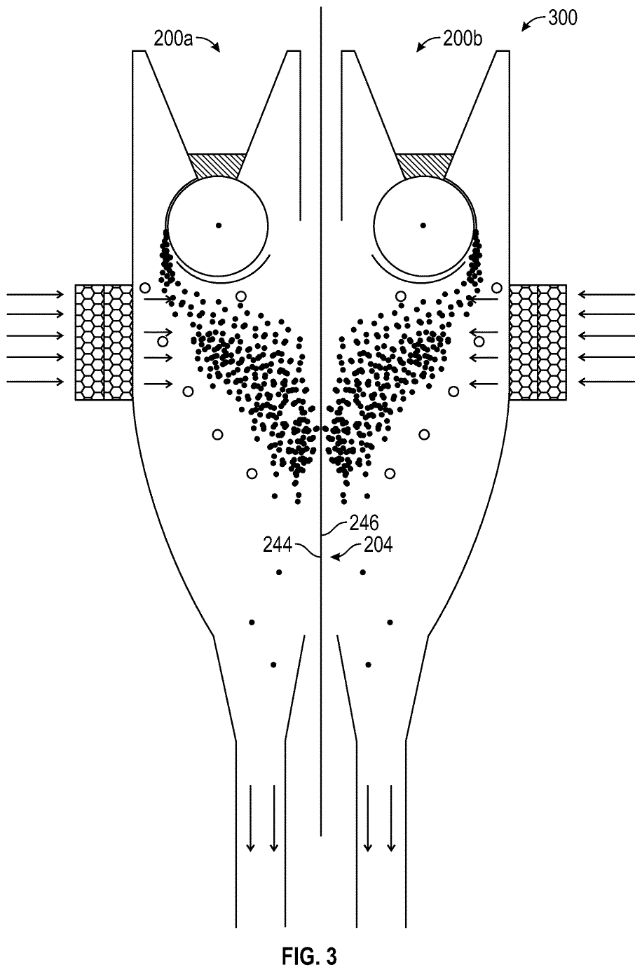

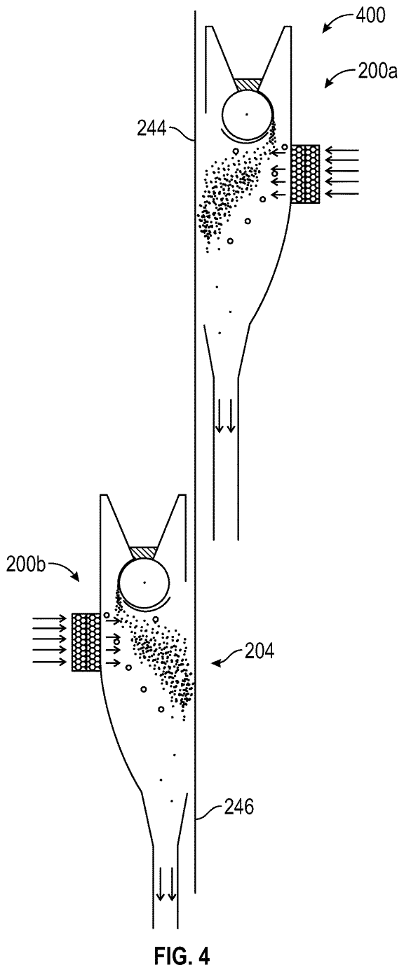

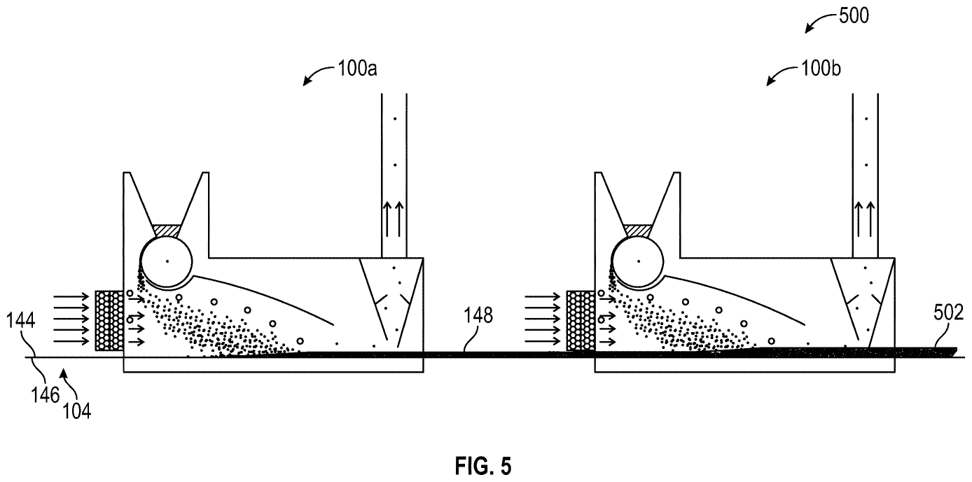

Although the system discussed herein is described as a single coating module, it should be understood that in some embodiments, the coating modules can be combined in a variety of forms and/or configurations. In some embodiments, the coating modules can be situated vertically on a single side or mirrored onto the second side of the web to achieve a dual-sided simultaneous coating processes (see, e.g., FIG. 3). In some embodiments, the coating modules can be offset (see, e.g., FIG. 4). In some embodiments, the coating modules can be placed in series such that the output of one module is fed as input to be the subsequent module, with each coating module applying a coating to the web. In some embodiments, any number of coating modules can be combined in series to achieve the desired coating outcome. FIG. 5 shows such in series configuration for a horizontal orientation of the system, although a similar arrangement could be incorporated into a vertical orientation of the system.

FIG. 1 is a diagrammatic view of an exemplary electrostatic coating system 100 (hereinafter “system 100”) in a horizontal orientation. The system 100 includes an electrostatic coating chamber 102 that receives a continuously moving substrate or web 104. The web 104 travels through the chamber 102 along a direction 106, referred to as a machine direction (MD), and the orthogonal direction can be referred to as the cross direction (CD). The horizontal orientation refers to a chamber 102 that allows the web 104 to move in a left-to-right or right-to-left direction, e.g., substantially parallel to horizontal.

At a top section, the system 100 includes a hopper 108 configured to receive a dry powder mixture 110. In some embodiments, the walls of the hopper 108 can angle inwardly towards each other and the bottom space of the hopper 108 to maintain a substantially constant level of the powder mixture 110 along the width and/or length of the hopper 108. For example, the hopper 108 can define a substantially V-shaped cross-section. The top of the hopper 108 can be open to receive the powder mixture 110, and the opposing end defines an outlet opening 112 that is disposed directly above a powder dispensing roller 114 (e.g., a roller that allows for dispensing and/or scattering of powder). The roller 114 rotates along an axis 116 that extends along the cross direction over the width of the web 104. As the powder mixture 110 drops on the roller 114, the roller 114 begins to initially disperse the powder mixture 110 in an initial dispersion zone 118 relying on the force of gravity.

The system 100 includes an air supply system 120 disposed outside of the chamber 102 and directing air (laminar and/or controlled turbulent) into the chamber 102. In some embodiments, laminar air flow can be used to more effectively disperse the powder cloud. Laminar air flow can be used to disperse the powder cloud in a controlled manner that enables the electrostatics of the system 100 to be the dominant force during disposition. However, in some embodiments, the system 100 can be used with turbulent air flow and the electrodes can provide the same charging and guiding effect, as discussed herein. In a system 100 having turbulent air flow, the position of the electrodes may be adjusted to ensure proper charging and guiding can be achieved even with the faster movement of particles within the coating chamber 102.

Therefore, in some embodiments, the system 100 can operate with only laminar air flow (as compared to conventional systems), but could also be incorporated into a turbulent air flow system if needed. The system 100 can include a turbulence controlling structure 122 disposed outside of the chamber 102 with multiple openings 124 through which the supplied air passes in horizontal direction 126 before entry into the chamber 102. In some embodiments, the openings 124 can be in the form of a honeycomb pattern, although alternative opening 124 configurations are envisioned. Air that has passed through the structure 122 is filtered and diffused before passage into the chamber 102. The configuration of the structure 122 can also serve to control turbulence in the air flow introduced into the chamber 102. The air introduced into the chamber 102 is directed at the powder mixture 110 dropping towards the web 104 from the initial dispersion zone 118. Such interaction with the air results in the powder mixture 110 being further dispersed over the web 104 within a main dispersion zone 128 (e.g., a dispersed powder cloud).

The system 100 includes multiple electrodes 130-142 (e.g., corona discharge wire electrodes, an electrode web or net, or the like) selectively positioned within the chamber 102. In some embodiments, electrodes 130, 132 can be disposed within the chamber 102 adjacent to the wall associated with the air input. The electrodes 130, 132 can be vertically spaced from each other, and provide an electrostatic charge to the particles of the powder mixture 110 within the initial dispersion zone 118 and the main dispersion zone 128. In some embodiments, the electrodes 130, 132 can also act as guiding electrodes for guiding the electrostatically charged particles towards the web 104. However, most of the guidance to the particles at the location of the electrodes 130, 132 can be provided by the air flow introduced into the chamber 102.

The electrode 134 can be disposed on the opposing side of the roller 114 and horizontally spaced from the electrode 130. In some embodiments, the height of the electrode 134 within the chamber 102 can be substantially similar to the height of the electrode 130. The electrodes 136-142 can be incrementally spaced/offset from each other (both horizontally and vertically relative to the web 104), starting from the electrode 134, both horizontally and vertically to define a downward arc 174 in the direction of the web 104. The position of the electrodes 136-142 therefore moves further from the air supply intake and further down towards the web 104 (e.g., a narrowing configuration). The distance of the electrodes 134-142 from the top surface 144 of the web 104 (e.g., or the web 104 in general) therefore decreases in the downstream direction of the coating chamber 102. The electrodes 136-142 can provide both an electrostatic charging function and a guiding function, depending on whether the particles within the zone 128 have been charged. In general, the electrodes 134-142 furthest from the roller 114 can provide more of the guiding functionality, while electrodes 134-142 closest to the roller 114 can provide more of the charging functionality. However, the transition between charging and guiding can be gradual, and can be shared by one or more electrodes.

For example, electrode 134 can primarily provide a charging functionality to the powder cloud. As the powder cloud moves further within the zone 128, more particles become electrostatically charged. Therefore, while electrode 136 can still provide a charging functionality (less than electrode 134), electrode 136 can begin to provide a guiding functionality as well for guiding the charged particles downward towards the web 104. Electrode 138 can provide less charging functionality and more guiding functionality than electrode 136. Electrode 140 can provide less charging functionality and more guiding functionality than electrode 138. Electrode 142 can provide less charging functionality and more guiding functionality than electrode 140.

The web 104 includes a substantially planar top surface 144 and a substantially planar bottom surface 146. Although discussed herein as being used to coat the top surface 144, the system 100 could be configured to similarly coat the top and bottom surfaces 144, 146. Upon initial entry into the chamber 102, the top surface 144 is uncoated. As the web 104 travels in direction 106 within the chamber 102, the dispersed particles begin to drop onto and coat the top surface 144. While the air flow into the chamber 102 disperses the particles, the electrodes 130, 132, 134 (and optionally electrodes 136-142) can electrostatically charge the particles. The electrodes 136-142 (and optionally electrodes 130-134) providing a guiding function for directing the electrostatically charged particles downward towards the top surface 144 of the web 104, ensuring a uniform coating. The electrodes 130-142 of the system 100 can therefore providing simultaneous charging and guiding to the particles. In particular, the electrostatically charged particles are repelled by similar charges and the associated electric fields. The electrodes 136-142 (and optionally electrodes 130-134) produce similar plasma zones (e.g., corona discharge, or the like), which effectively produce a wall of negatively charged ions, repelling the charged powder particles in the desired location, e.g., towards the top surface 144 of the web 104. The electrodes 130-142 of the system 100 therefore serve a dual functionality, which advantageously results in a uniform coating of the web 104 at coated web section 148. In some embodiments, the voltage for the electrodes 130-142 can be varied or different depending on the type of function being performed. For example, electrodes 130-142 performing primarily a charging function can have a different voltage from electrodes 130-142 that primarily perform a guiding function. Electrodes 130-142 that are configured to serve both a charging and guiding function in a substantially equal manner can have the same or substantially same voltage.

In some embodiments, the system 100 can include a plasma deflection shield 150 disposed within the chamber 102. The shield 150 can be formed to limit the mobility of charged particles within the guiding zone, although the shield 150 can provide protection in other areas of the chamber 102 as well. For example, one section 152 of the shield 150 can define a substantially semicircular shape complementary to the curvature of the roller 114, and is disposed immediately below the roller 114. The section 152 is offset from the zone 118 to allow for the powder particles to drop from the roller 114 and into the zones 118, 128. The section 152 can prevent or reduce passage of powder particles towards the roller 114, thereby eliminating the risk of powder coating onto the roller.

The shield 150 includes a curved section 154 that extends from a first end 156 at the end of the section 152 to a second end 158 downstream of the electrode 142. The curved section 154 of the shield 150 is disposed above the electrodes 134-142 and can generally mimic or be complementary to the curved positioning of the electrodes 134-142. The curved section 154 therefore curves downwardly from an area near the roller 114 towards the web 104. The curved section 154 deflects any particles that may pass between the electrodes 134-142 back towards the web 104. Although illustrated with two electrodes 130-132 at the air intake and five electrodes 134-142 above the zone 128, it should be understood that more or less electrodes could be used to ensure sufficient electrostatic charging and to achieve the desired guidance effect.

At the downstream end of the chamber 102, the system 100 includes an exhaust assembly 160 for removing any unused powder particles 162 and recycling such particles 162 for future use. The exhaust assembly 160 can include a diffuser 164 with an opening 166 in the walls disposed directly above the top surface 144 of the coated web 104 such that any loose particles 162 can be captured. The inner walls of the diffuser 164 can include one or more diffuser/distributor flanges 168. The diffuser 164 connects to an exhaust duct 170 that has negative pressure air forced in direction 172 for exhaust of the fugitive powder from the chamber 102. The exhausted powder can be collected and reused (e.g., reintroduced into the hopper 108) for coating of the web 104. The system 100 therefore provides an efficient and effective way of dispersing a dry powder cloud over the web 104 for electrostatic charging, and uses electrodes in a dual function manner to provide guidance to the electrostatically charged particles to direct such particles to the top surface 144 of the web 104. The combination of charging and guiding functionalities of the electrodes ensures a high uniformity of the coating at high mass flow rates of the powder.

FIG. 2 is a diagrammatic view of an exemplary electrostatic coating system 200 (hereinafter “system 200”) in a vertical orientation. The system 200 can be substantially similar in structure and/or function to the system 100, except for the distinctions noted herein. The system 200 includes an electrostatic coating chamber 202 that receives a continuously moving substrate or web 204. The chamber 202 is oriented vertically such that the web 204 travels from an upper position to a lower position, e.g., substantially perpendicular to horizontal. The machine direction 206 of the system 200 is therefore downward rather than side-to-side. The systems discussed herein can be orientation agnostic, e.g., oriented at any angle between the horizontal orientation of system 100 and the vertical orientation of system 200.

The system 200 also includes a hopper 208 that receives a dry powder mixture 210 for output through a bottom opening 212. The hopper 208 defines a V-shaped configuration with tapered walls to guide the powder mixture 210 towards the opening 212. The opening 212 is positioned directly above a powder dispensing roller 114 that rotates along axis 216 to initially disperse the powder mixture 210 in the initial dispersion zone 218 relying on the force of gravity.

The system 200 also includes an air supply system 220 disposed outside of the chamber 202. Rather than supplying air into the chamber 202 in a direction substantially parallel to the machine direction (as done in the system 100 of FIG. 1), the system 220 supplies air into the chamber 202 in a direction perpendicular to the machine direction 206. Air from the system 220 travels along direction 226 through a filtration and/or diffusion structure 222 having an array of openings 224 (e.g., honeycomb openings, or the like) before entry into the chamber 202. Air entering into the chamber 202 further disperses the powder mixture 210 towards the web 204 at a main dispersion zone 228 (e.g., a dispersed powder cloud).

The system 200 includes multiple electrodes 230-240 (e.g., corona discharge wire electrodes, an electrode web or net, or the like) selectively positioned within the chamber 202. One electrode 230 can be positioned adjacent to the wall associated with the air input, and electrode 232 can be positioned further below the roller 214 or on the opposing side of the roller 214 from electrode 230. The electrodes 230, 232 are therefore horizontally spaced from each other within the chamber 202, and provide an electrostatic charge to the particles dispersed by the air stream. Although the electrodes 230, 232 can also provide a guiding function to the charged particles, in this area of the chamber 202, the guidance can be primarily provided by the air flow introduced into the chamber 202.

The electrodes 234-240 can be incrementally spaced/offset from each other, starting from the electrode 230, both horizontally and vertically to define a rightward arc in the direction of the web 204. The position of the electrodes 234-240 therefore moves further from the air supply intake and further right towards the web 204. The electrodes 234-240 can provide both an electrostatic charging function and a guiding function, depending on whether the particles within the zone 228 were previously charged. Out of the electrodes 234-240, the electrodes furthest from the roller 214 (e.g., electrodes 238, 240) can provide more of the guiding functionality, while electrodes closest to the roller 214 (e.g., electrodes 234, 236) can provide more of the charging functionality. However, the transition between charging and guiding can be gradual, and can be shared by one or more electrodes. Once the particles have been charged, the remaining downstream electrodes can guide the particles rightward towards the web 204. The web 204 includes a planar top surface 244 and a planar bottom surface 226. The web 204 enters the chamber 202 with the top surface 244 uncoated, and as the web travels in the direction 206, the electrodes 230-240 electrostatically charge the particles and guide them towards the top surface 244 to coat the web 204.

In some embodiments, the system 200 can include a plasma deflection shield 252 disposed within the chamber. The shield 252 limits the mobility of charged particles within the guiding zone and other areas of the chamber 202. The shield 252 can be disposed directly below the roller 214 and defines a substantially semicircular, complementary shape. The shield 252 prevents or reduces passage of powder particles towards the roller 214. In some embodiments, the system 200 can include a second shield formed either integrally or separately from the shield 252 to deflect and direct particles towards the web 204 without interfering with the airflow input into the system 200.

At the downstream end of the chamber 202, the system 200 includes an exhaust assembly 260 for removing any unused powder particles 262 and recycling such particles 262 for future use. The assembly 260 can include inwardly tapered duct walls 264 that extend towards an exhaust duct 266 for exhausting fugitive powder from the chamber 202 in direction 268. The exhausted powder can be collected and reused (e.g., reintroduced into the hopper 208) for coating of the web 204. In some embodiments, the system 200 can include a diffuser before the walls 264 (similar to diffuser 164 of the system 100 of FIG. 1). The system 200 therefore provides an efficient and effective way of dispersing a dry powder cloud towards the web 204 for electrostatic charging, and uses electrodes in a dual function manner to provide guidance to the electrostatically charged particles to direct such particles to the top surface 244 of the web 204. The combination of charging and guiding functionalities of the electrodes ensures a high uniformity of the coating at high mass flow rates of the powder.

As discussed herein, the system can be in a variety of configurations. For example, in some embodiments, the system 300 can be in the form of a dual-sided simultaneous coating configuration, as illustrated in FIG. 3. The system 300 includes a coating system 200a and a coating system 200b disposed on opposing sides of the web 204 (e.g., a mirrored layout). Each of systems 200a, 200b can be substantially similar to system 200 of FIG. 2. In the configuration of FIG. 3, the web 204 passes in-between the systems 200a, 200b such that the system 200a coats the top surface 244 and the system 200b simultaneously coats the bottom surface 246.

As another example, in some embodiments, the system 400 can be in the form of a dual-sided offset coating configuration, as illustrated in FIG. 4. The system 400 includes a coating system 200a and a coating system 200b disposed on opposing sides of the web 204 and offset from each other in the machine direction. Each of systems 200a, 200b can be substantially similar to system 200 of FIG. 2. In the configuration of FIG. 4, the web 204 passes first through system 200a such that the bottom surface 246 of the web 204 is coated, and the web 204 continues to system 200b such that the top surface 244 of the web 204 is subsequently coated. Both surfaces 244, 246 of the web 204 can thereby be coated at different times.

As another example, in some embodiments, the system 500 can be in the form of a single-sided in series coating configuration, as illustrated in FIG. 5. The system 500 includes a coating system 100a and a coating system 100b disposed on the same side of the web 104 and offset from each other in the machine direction. Each of systems 100a, 100b can be substantially similar to system 100 of FIG. 1. In the configuration of FIG. 5, the web 104 passes first through system 100a such that the top surface 144 of the web 104 is coated with a first layer at a coated web section 148. The web 104 subsequently travels through system 100b where the coated web section 148 is further coated to achieve an updated coated web section 502 which has a thickness greater than the thickness of coated web section 148. Multiple systems can be positioned in series to achieve the desired final coated web thickness. In addition, multiple configurations for single and/or double-sided coating systems can be combined to achieve the desired coated web.

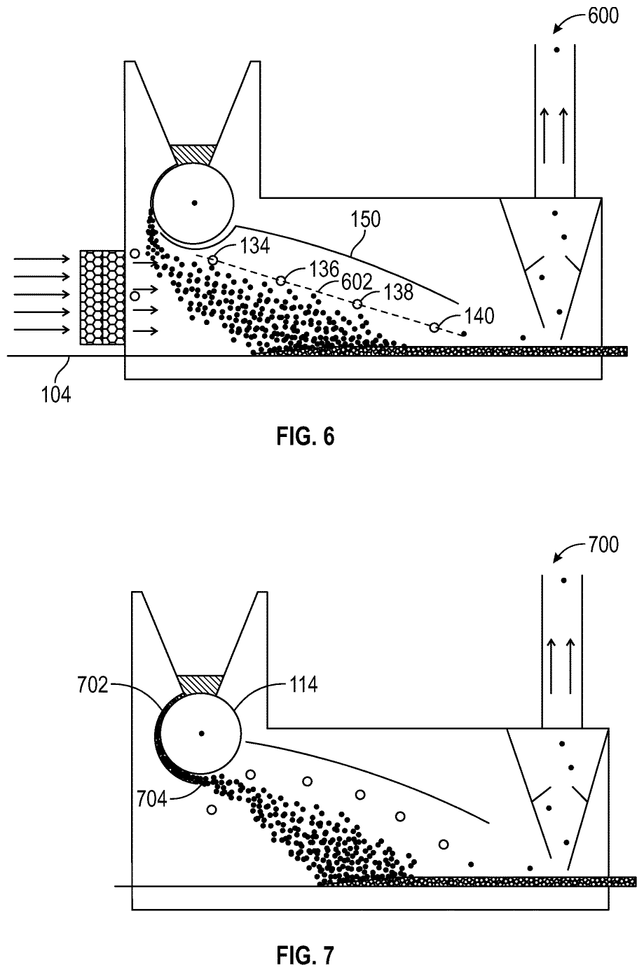

In some embodiments, the narrowing configuration of the electrodes within the coating chamber can be in a configuration other than an arc configuration. For example, FIG. 6 illustrates an exemplary electrostatic coating system 600 with electrodes 134-140 disposed along a narrowing configuration defined by a substantially linear line 602. In the narrowing configuration of FIG. 6, the distance of the adjacently positioned electrodes 134-140 relative to the web 104 incrementally decreases such that the electrodes 134-140 are closer to the web 104 downstream than upstream along the moving web 104. Such narrowing configuration allows the electrodes 134-140 to charge the powder particles while simultaneously (or subsequently) guiding the particles towards the web 104. The narrowing configuration used in the exemplary systems discussed herein can therefore be in the arc configuration of FIG. 1, the linear line configuration of FIG. 6, or any other configuration in which the distance of the electrodes relative to the web is incrementally decreased in the downstream direction to provide guidance of the powder particles towards the surface of the web for even coating of the web. Other than the positioning of the electrodes 134-140, the system 600 can be substantially similar in structure and function to the system 100. In some embodiments, the shield 150 can still define a curved extension even if the electrodes 134-140 are disposed in the linear line 602 configuration. In some embodiments, the shield 150 can define a substantially linear extension complementary to the linear line 602 of the electrodes 134-140.

In some embodiments, the systems discussed herein can incorporate a variety of dispersion means. For example, the system 600 of FIG. 6 can incorporate air supply means that provide laminar air flow to the chamber for uniformly dispersing the powder particles. After dispersion, the electrodes can charge and guide the powder particles towards the surface of the web.

In some embodiments, as illustrated in the system 700 of FIG. 7, the roller 114 can include a textured outer surface, brushes and/or bristles (e.g., mechanical means) to direct the powder particles into the coating chamber while simultaneously at least partially dispersing the powder particles. In some embodiments, the system 700 can include a guiding plate 702 defining a curvature substantially complementary to the curvature of the roller 114 to assist with directing the dispersed particles from an outlet 704 between the electrodes. Once partially dispersed, the electrodes can charge and guide the power particles towards the surface of the web. In some embodiments, the mechanical dispersion means can be in the form of one or more nozzles configured to direct and at least partially disperse the powder particles within the coating chamber.

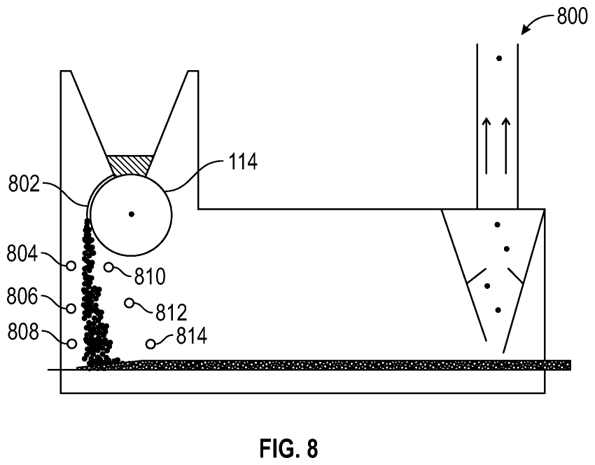

In some embodiments, as illustrated in the system 800 of FIG. 8, the roller 114 can generally direct the power particles 802 along its surface to drop the particles 802 into the coating chamber with only the assistance of gravity. In particular, the system 800 does not use an air flow or mechanical means for dispersing the particles 802, and instead relies on the particles 802 to disperse and they drop with the assistance of gravity towards the web. In such embodiments, the electrodes 804-814 can be positioned on opposing sides of the power particle stream to charge and guide the particles 802 towards the surface of the web. In some embodiments, the distance between the roller 114 and the web can be increased to allow for the particles 802 falling with the assistance of gravity to disperse sufficiently for charging and guiding of the particles 802 to occur before reaching the web surface.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An electrostatic coating system, comprising:
a coating chamber configured to receive a dry powder mixture, and further configured to receive a web including a top surface and an opposing bottom surface that travels through the coating chamber;
a dispensing assembly configured to dispense the dry powder mixture into the coating chamber;
a charging assembly associated with the coating chamber; and
an airflow system configured to control airflow passing through the coating chamber.

2. The system of claim 1, wherein the charging assembly includes electrodes disposed within the coating chamber.

3. The system of claim 2, wherein the electrodes operate as dual function electrodes by (i) electrostatically charging particles of the dry powder mixture introduced into the coating chamber, and (ii) once the particles of the dry powder mixture have been electrostatically charged, guiding the electrostatically charged particles towards the web.

4. The system of claim 1, wherein the dry powder mixture including active materials, binder, and conductive additives.

5. The system of claim 1, wherein:
the dispensing assembly includes a hopper positioned over the coating chamber, wherein the hopper is configured to receive the dry powder mixture and introduce the dry powder mixture into the coating chamber; and
the dispensing assembly includes a dispensing roller disposed below the hopper, the dispensing roller rotating to initially disperse the dry powder mixture into the coating chamber.

6. (canceled)

7. The system of claim 1, wherein:
the airflow system includes an air supply means for directing air flow into the coating chamber to disperse the dry powder mixture over the web; and
the airflow system maintains an air velocity of about 25-750 fpm, inclusive, through the coating chamber.

8. (canceled)

9. The system of claim 1, wherein the airflow system includes a turbulence controlling structure disposed upstream of the coating chamber and configured to control turbulence in the air flow.

10. The system of claim 9, wherein at least one of:
(i) the turbulence controlling structure is configured to control the turbulence in the air flow to achieve laminar air flow prior to entry of the laminar air flow into the coating chamber; or
(ii) the turbulence controlling structure includes an array of openings through which the air flow passes.

11. (canceled)

12. The system of claim 11, wherein if (ii), the openings of the array each define a honeycomb configuration.

13. The system of claim 9, wherein the turbulence controlling structure defines an open cross-sectional area between about 50-90%, inclusive.

14. The system of claim 1, wherein the airflow system includes an air supply means for directing air flow into the coating chamber to guide the dry powder mixture introduced into the chamber towards the charging assembly.

15. The system of claim 2, wherein the electrodes are positioned in a narrowing configuration with a distance between adjacently positioned electrodes and the web gradually reducing in a downstream direction of the coating chamber.

16. The system of claim 15, wherein the narrowing configuration is an arc configuration or a linear configuration shifting downwardly towards the web in the downstream direction of the coating chamber to guide the electrostatically charged particles towards the web for coating.

17. The system of claim 15, wherein each of the electrodes in the narrowing configuration is physically spaced from each other by both a vertical and horizontal distance relative to the web.

18. The system of claim 2, wherein each of the electrodes is capable of electrostatically charging the particles and guiding the electrostatically charged particles.

19. The system of claim 15, comprising a deflection shield disposed within the coating chamber to control mobility of ions and charged particles created by corona discharge, wherein the deflection shield includes at least one of (i) a first section disposed at least partially below a dispensing roller to prevent return of the particles to the dispensing roller, and (ii) a curved section disposed above the narrowing configuration of the electrodes.

20. (canceled)

21. The system of claim 20, wherein:
the curved section defines a curvature complementary to the narrowing configuration of the electrodes, with a distance of a first end of the curved section further from the web than a distance of an opposing second end of the curved section; and
the curved section assists with guiding the electrostatically charged particles towards the web.

22. (canceled)

23. The system of claim 1, wherein the airflow system includes an exhaust assembly with negative pressure air to remove fugitive particles that have not coated the web.

24. A method of electrostatic dry powder coating, the method comprising:
passing a web through a coating chamber of an electrostatic coating system, the web including a top surface and an opposing bottom surface;
dispensing a dry powder mixture into the coating chamber with a dispensing assembly;
controlling airflow passing through the coating chamber with an airflow system; and
charging particles of the dry powder mixture with a charging assembly.

25. The method of claim 24, wherein;
charging the particles of the dry powder mixture with the charging assembly comprises electrostatically charging the particles of the dry powder mixture with electrodes of the charging assembly; and
the method comprises guiding the electrostatically charged particles towards the web with the electrodes of the charging assembly.

26. (canceled)
